(19) United States
(12) Patent Application Publication
(10) Pub. No.: US 2024/0221484 A1
(43) Pub. Date: Jul. 4, 2024

(54) System and Method for Monitoring and Determining Operational Efficiency of a Surveillance System

(71) Applicant: GATEKEEPER SECURITY, INC., Sterling, VA (US)

(72) Inventors: Kevin Dexter, Collingswood, NJ (US); Robert Smith, Delran, NJ (US); Robert Rozploch, Newtown, PA (US)

(21) Appl. No.: 18/551,176

(22) PCT Filed: Jan. 26, 2022
(86) PCT No.: PCT/US2022/013783

§ 371 Date: Sep. 18, 2023

Related U.S. Application Data
(60) Provisional application No. 63/166,776, filed on Mar. 26, 2021.

(51) Int. Cl. G08B 21/18; G07C 5/00; G08B 29/04

(52) U.S. Cl. CPC G08B 21/185; G07C 5/008; G08B 21/182; G08B 29/04

(57) ABSTRACT

A computer system and method for preforming autonomous electronic monitoring of a surveillance system for determining operational efficiency, identifying improper operation of one or more components of the surveillance system, and controlling one or more aspects of the monitored surveillance system for rectifying improper operation. Electronic data is received from one or more electronic detection devices that capture data regarding a monitored object, such as a vehicle. The received electronic data is analyzed to determine operational efficiency of the one or more electronic detection devices. An alert message is generated and transmitted to an intended recipient if one or more electronic detection devices of the monitored surveillance system is determined to have improper operational efficiency so as to cause correction of the determined improper operation of the one or more detection devices.

### CROSS REFERENCE TO RELATED APPLICATIONS

This application claims priority to U.S. Provisional Patent Application Ser. No. 63/166,766 filed Mar. 26, 2021, the disclosure of which is herein incorporated by reference in its entirety

### FIELD OF THE INVENTION

The disclosed embodiments generally relate to surveillance systems, and more particularly to monitoring the operational efficiency of camera based security and surveillance systems.

### BACKGROUND OF THE INVENTION

At security check points, border crossings, traffic management systems, access control checkpoints, and the like it, is desirable to ensure such systems operate at the highest functional of performance (imaging levels) and remain functioning over the maximum duration of time. When vital imaging, or other supporting components, of such surveillance systems stop working or work under impaired (non-optimal) performance, the security aspects of such location and overall operations may be compromised. This shut down of functionality or degraded functionality can also impact the ability to keep travelers, vehicles, or cargo moving across such checkpoints, causing significant time delays in crossing borders or gaining needed access to such surveilled locations. At traditional access control or border crossing checkpoints, camera functionality or performance degradation can often take several hours before operators of such systems are alerted regarding the equipment health status before qualified personnel are dispatched to repair such components. In such imaging-based surveillance applications, it can be desirable to know as soon as possible if a hard failure (complete shutdown of an imaging component) has occurred or if a imaging component is still operational, but perhaps is functioning at less-than optimal performance. It is desirable to have such soft-failures identified and can be alerted to operational personnel to address the issue as quickly as possible, often as a preventative maintenance measures prior to the system being rendered inoperable for the applications intended for surveillance purposes.

Currently, conventional techniques involving the manual inspection of imaging and support equipment have been considered satisfactory for their intended purpose. However, there is a present and increasing need for improved and more autonomous real-time apparatus and methods for monitoring and alerting regarding the operational health of surveillance systems.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

In furtherance of the illustrated embodiments discussed herein, it is to be appreciated and understood described is a computer system and method for preforming autonomous electronic monitoring of a surveillance system for determining operational efficiency, identifying improper operation of one or more components of the surveillance system, and controlling one or more aspects of the monitored surveillance system for rectifying improper operation. Electronic data is received from one or more electronic detection devices that capture data regarding a monitored object, such as a vehicle. The received electronic data is analyzed to determine operational efficiency of the one or more electronic detection devices. An alert message is generated and transmitted to an intended recipient if one or more electronic detection devices of the monitored surveillance system is determined to have improper operational efficiency so as to cause correction of the determined improper operation of the one or more detection devices.

### BRIEF DESCRIPTION OF THE DRAWINGS

The accompanying appendices and/or drawings illustrate various non-limiting, example, inventive aspects in accordance with the present disclosure:

FIG. 1 illustrates an exemplary system overview and data-flow for use with an illustrated embodiment for depicting system operation;

FIG. 2 illustrates an example user computing device configured in accordance with the illustrated embodiments;

FIG. 3 illustrates a generalized surveillance system in accordance with the illustrated embodiments; and

FIG. 4 illustrates a flow diagram depicting operation of the surveillance system in accordance with the illustrated embodiments.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

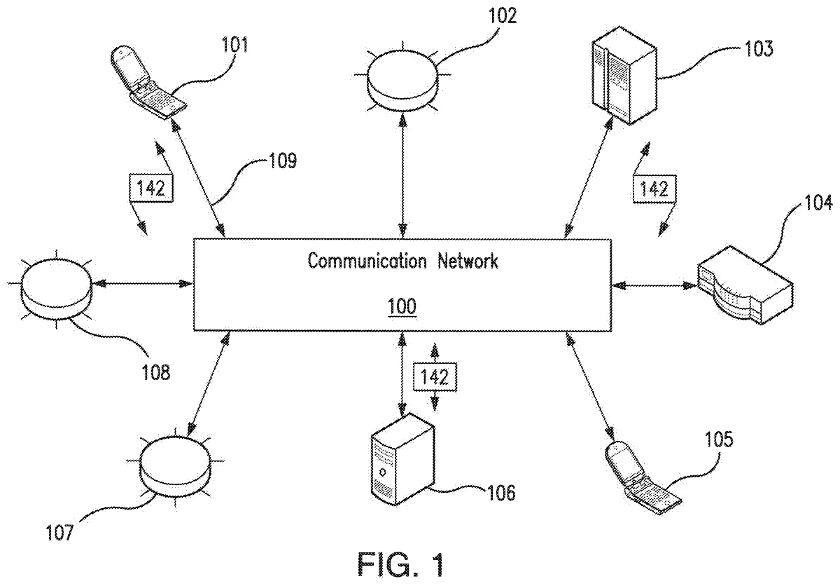

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, workstations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/user devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium (e.g., such as an “app” downloadable from an app store (e.g., iTunes™)) or a computer readable storage medium. A computer readable storage medium may be, for example, but not limited to, an electronic, magnetic, optical, electromagnetic, infrared, or semiconductor system, apparatus, or device, cloud service or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, an or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the illustrated embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to embodiments of the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

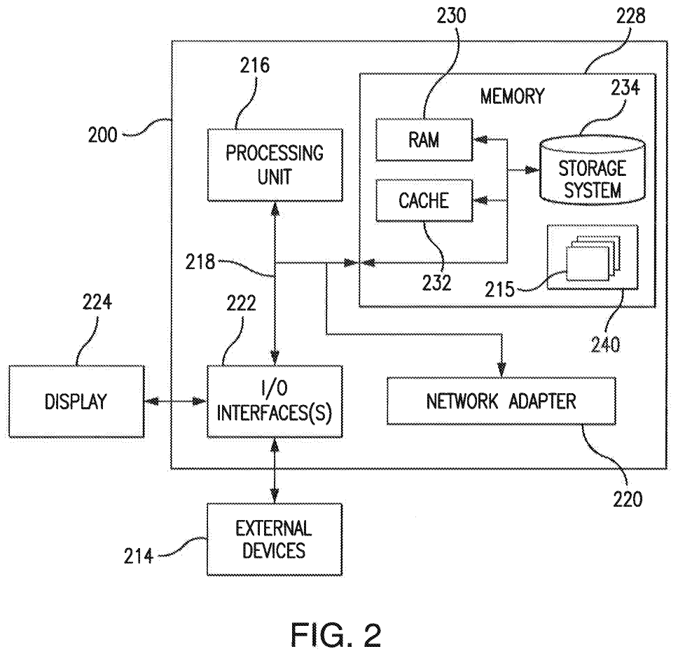

With reference now to FIG. 2, shown is a schematic block diagram of an example network user computing device 200 (e.g., computer 103, etc.) that may be used (or components thereof) with one or more illustrated embodiments described herein. As explained above, in different embodiments these various devices are configured to communicate with each other in any suitable way, such as, for example, via communication network 100.

Device 200 is intended to represent any type of user computer system capable of carrying out the teachings of various embodiments of the illustrated embodiments. Device 200 is only one example of a suitable system and is not intended to suggest any limitation as to the scope of use or functionality of embodiments of the illustrated embodiments described herein. Regardless, user device 200 is capable of being implemented and/or performing any of the functionality set forth herein.

User device 200 is operational with special purpose computing system environments or configurations. Examples of computing systems, environments, and/or configurations that may be suitable for use with computing device 200 include, but are not limited to, tablet devices and preferably other portable user computing devices (e.g., desktop computer and server computers) that include any of the above systems or devices, and the like.

User device 200 may be described in the general context of computer system-executable instructions, such as program modules, being executed by a computer system. Generally, program modules may include routines, programs, objects, components, logic, data structures, and so on that perform particular tasks or implement particular abstract data types. User device 200 may be practiced in distributed data processing environments where tasks are performed by remote processing devices that are linked through a communications network. In a distributed data processing environment, program modules may be located in both local and remote computer system storage media including memory storage devices.

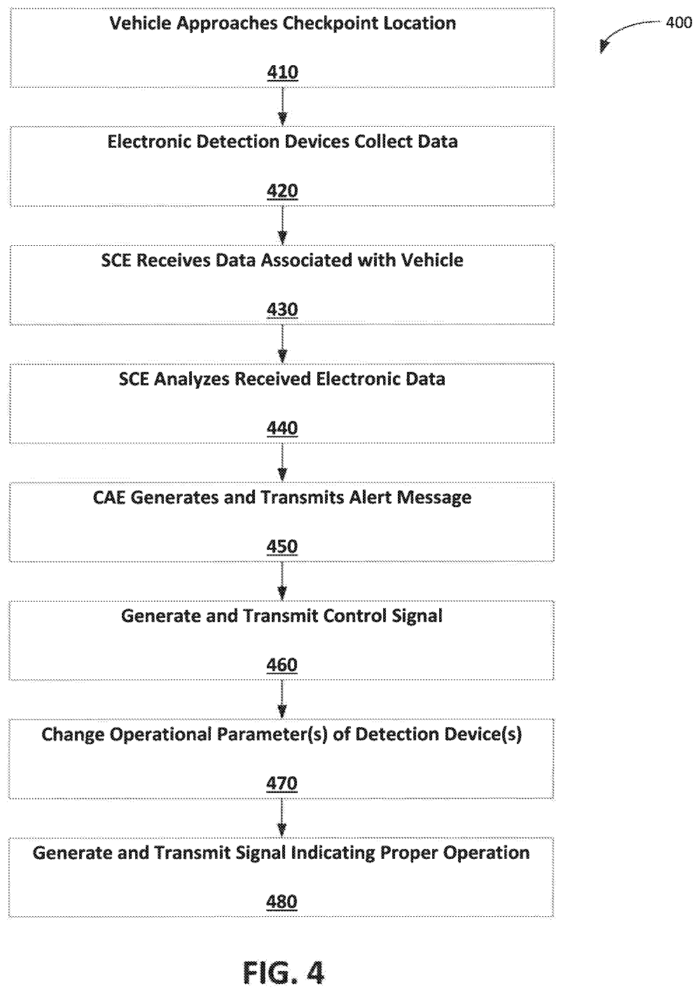

User device 200 is shown in FIG. 2 in the form of a user computing device. The components of device 200 may include, but are not limited to, one or more processors or processing units 216, a system memory 228, and a bus 218 that couples various system components including system memory 228 to processor 216 and preferably to a plurality of electronic detection devices (e.g., 102 (FIG. 1)) utilized in a surveillance system 400 (FIG. 4), including (but not limited to) a plurality of camera devices (e.g., 420-430) and sensory devices (e.g., 440, 442) in accordance with the below illustrated embodiments.

With continued reference to FIG. 2, bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

User device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). As will be further depicted and described below, memory 228 may include at least one program product having a set (e.g., at least one) of program modules that are configured to carry out the functions of embodiments of the invention.

Program/utility 240, having a set (at least one) of program modules 215, such as a Statistical Computing Engine (SCE) 316 and Computing Alert Engine (CAE) 314, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the illustrated embodiments as described herein.

Device 200 may also communicate with one or more external devices 214 such as a keyboard, a pointing device, one or more camera components, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as cellular networks (e.g., TDMA, CDMA, 4g and 5g); a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described illustrated embodiments may be implemented. FIGS. 1 and 2 are exemplary of a suitable environment and are not intended to suggest any limitation as to the structure, scope of use, or functionality of an embodiment of the illustrated embodiments. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With the exemplary communication network 100 (FIG. 1) and user device 200 (FIG. 2) being generally shown and discussed above, description of certain illustrated embodiments of the present invention will now be provided. It is to be appreciated the certain below described illustrated embodiments relate to surveillance systems, and particularly surveillance systems utilized in international border crossings where a vehicle attempts to cross an international border. For brevity of discussion, description is provided below regarding autonomous electronic monitoring for determining operational efficiency and controlling one or more aspects of a vehicle monitoring system used in such international border crossing environments. A more generalized description of the environment of use relating to border control systems can be found in commonly assigned U.S. patent application Ser. No. 15/981,694 filed May 16, 2018, Ser. No. 16/154,130 filed Oct. 8, 2018, Ser. No. 16/808,725 filed Mar. 4, 2020, Ser. No. 17/119,777 filed Dec. 11, 2020; and U.S. Pat. No. 10,867,193 issued Dec. 15, 2020, each of which is incorporated herein in their entirety.

It is to be further appreciated and understood that while the below illustrated embodiments are described in relation to surveillance systems utilized in international border crossings, they are not to be understood to be limited to application at an international border as they may be utilized in any surveillance system adapted for autonomous electronic monitoring, determining operational efficiency and controlling one or more aspects of the surveillance system.

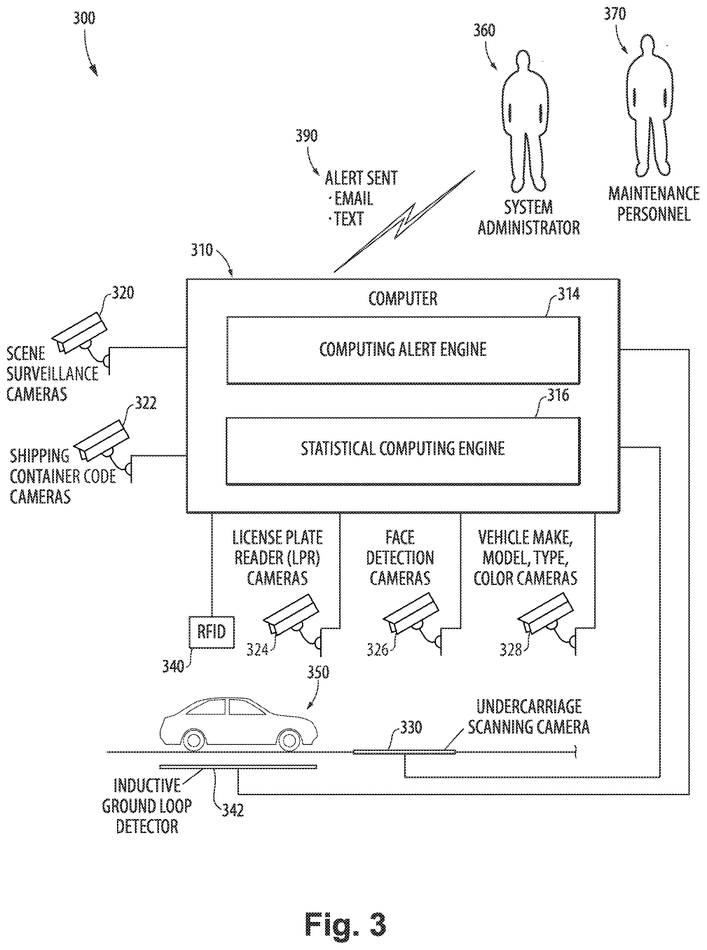

With reference now to FIG. 3 (and with continuing reference to FIGS. 1 and 2), shown is a generalized system for autonomously monitoring a surveillance system for determining operational efficiency and controlling one or more aspects of a vehicle monitoring system, depicted generally by reference numeral 300. Surveillance system 300 includes a computer system 310 (having one or more components of computer device 200 coupled to network 100), preferably having a Statistical Computing Engine (SCE) 316 and a Computing Alert Engine (CAE) 314 in accordance with certain illustrated embodiments, each of which may be embodied as separate hardware computing modules or embodied as stored programs within computing system 310. Coupled to the computer system 310 is a plurality of electronic detection devices (320-342) which may include a plurality of camera devices (320-328) and a plurality of electronic sensory devices (340-342) relating to detection of one or more aspects of a vehicle 342 (e.g., passenger vehicle, motor cycle, commercial truck, container truck, etc.). In accordance with the illustrated embodiments, the plurality of camera devices (320-328) may include one or more of a (but is not to be understood to be limited to): scene surveillance camera 320; shipping container code camera 322; License Plate Reader (LPR) Camera 324; Face Detection Camera 326; Vehicle Dimensional (make/model/type/color decoding) Camera 328 and Vehicle Undercarriage Camera 330. The plurality of electronic devices (320-342) may include one or more of a (but is not to be understood to be limited to): RFID Scanner 340 and Inductive Ground Loop Detector 342.

It is to be appreciated that in accordance with the certain illustrated embodiments, the electronic detection devices (320-342) are configured and operational to detect information from a vehicle 350 at a border crossing for surveillance purposes. For instance, a vehicle dimensional camera 328 may be operational to detect a make, model, vehicle type and color classification of a vehicle 350. A shipping container code camera 322 may be operational to detect and determine vertically and/or horizontally aligned ISO 6346/MOCO codes on one or more shipping containers positioned on one or more vehicles 350.

With the exemplary surveillance computing system 300 of FIG. 3 being generally shown and discussed above, and with continuing reference to FIGS. 1-3, reference is now made to FIG. 4 which depicts a flow chart demonstrating implementation of the various exemplary embodiments for providing autonomous electronic monitoring to determine operational efficiency and control of one or more aspects of the surveillance system 300 (designated generally by reference numeral 400) in accordance with certain illustrated embodiments. It is noted that the order of steps shown in process 400 of FIG. 4 is not required, so in principle, the various steps may be performed out of the illustrated order. Also certain steps may be skipped, different steps may be added or substituted, or selected steps or groups of steps may be performed in a separate application following the embodiments described herein. Starting at step 410, electronic data is preferably received by system 300 from the electronic detection devices (320-342) upon a vehicle 350 entering a checkpoint location at a border crossing location. Proceeding to step 420, and in one particular exemplary scenario, the inductive ground loop detector 342 may detect such a vehicle 350 entering a portion of a border crossing lane to cause/trigger capture of the electronic data relating to the vehicle 350. It is to be understood and appreciated that the received electronic data may consist of (but is not to be understood to be limited to) one or more of, as detected by the electronic detection devices (320-342): license plate decoding confidence scores; a number of license plates detected in an image field of view; vehicle make/model/type/color classification confidence scores; a number of faces detected inside a given vehicle; shipping container code ISO 6346/MOCO decoding confidence scores; checksum values indicative of shipping container code values decoded to equate to a valid checksum value of the various component fields in a decode payload; a number of anomalies and/or foreign objects detected from a vehicle undercarriage imaging scan; a number of consecutive RFID reads of a certain expected type that is consistent with an application scenario associated with a type of RFID tag. Additionally, one or more of the electronic detection devices (320-342) may identify and count individual faces within a vehicle 350.

It is to be further appreciated and understood the electronic data is preferably received by system 300 from the electronic detection devices (320-342) upon a vehicle 350 entering a checkpoint location at a border crossing location from a computer network 100 coupled to the one or more electronic detection devices (320-342) in electronic data packet format. Additionally, the aforesaid captured electronic data packets received from the computer network 100 may be encrypted whereby the surveillance system 300 is preferably configured and operational to decrypt the encrypted electronic data packets transmitted, via the computer network 100, from the one or more electronic detection devices (320-342).

Proceeding now to step 430, the received electronic data is analyzed in the surveillance computer system 310 to determine operational efficiency of the one or more electronic detection devices (320-342), preferably in the SCE 316 of surveillance system 300. It is to be understood the SCE 316 is preferably configured to determine real-time statistics over a variable and configurable window of data events, wherein the real-time statistics preferably includes at least one of average values and standard deviation. It is to be additionally appreciated that the variable and configurable window of data events may preferably be circular buffer based.

With reference to step 440, and in accordance with the illustrated embodiments, the received electronic data is analyzed in computer system 310 to determine operational efficiency (health) of the one or more electronic detection devices (320-342) utilized in surveillance system 300. It is to be understood the determined operational efficiency may be dependent upon a determined number of hard failures associated with the one or more electronic detection devices and/or dependent upon a determined number of preventative maintenance recommendations associated with an electronic detection device (320-342).

The below examples provides instances in which computer system 310 is operational and configured to determine the operational efficiency (health) of the one or more electronic detection devices (320-342) utilized in surveillance system 300. In a first instance, the computer system 310 analyzes the received electronic data by determining a variance between the received electronic data and stored reference operating data and/or conditions for the one of more electronic detection devices (320-342). For example, when the determined variance exceeds a predetermined threshold, this is indicative of improper operation by one or more of the electronic detection devices (320-342). It is noted the predetermined threshold may be contingent upon a predetermined time period. For instance, the computer system 310 may be configured and operational to analyze the received data to determine whether one or more electronic detection devices (320-342) is sending data after a prescribed number of vehicle events (which vehicle event may be a vehicle 350 entering a checkpoint location). As another example, the computer system 310 may be configured and operational to analyze the received electronic data by comparing a payload of data and images indicative of dropped (missing) camera images (preferably from the one or more camera devices 320-328) against a predetermined baseline system configuration of an electronic detection device (e.g., an electronic camera device). As yet another example, the computer system 310 may be configured and operational to analyze the received electronic data by preferably utilizing image decoding based confidence scores to determine if a camera component (preferably from the one or more camera devices 320-328) is out of focus, subject to improper focus and/or alignment, has obstructed optics, and/or is subject to degraded operation regarding imaging quality. It is to be understood the confidence scores may include, for instance, data relating to license plate decoders and facial detection of vehicle occupants. With regard to yet another example, the computer system 310 may be configured and operational to utilize data analytics to determine if sensory data and/or camera images are acquired in a predetermined order in association with predetermined timing and/or latency values.

Proceeding now to step 450, after the received electronic data is analyzed in computer system 310 to determine operational efficiency (health) of the one or more electronic detection devices (320-342) utilized in surveillance system 300 (steps 430-440), the computer system 310 is preferably operational and configured to generate and transmit an alert message 390 (preferably via the CAE 314) if the one or more electronic detection devices (320-342) is determined to have improper operational efficiency. Preferably the alert message 390 is transmitted, via a computer network 100, in any know electronic communication format including (but not to be limited to): email; txt message; telephonic voice message; social media; and other suitable communication formats that is indicative of the determined improper performance by one or more of the electronic detection devices (320-342) to a relevant user of surveillance system 300, such as a system administrator 360 and/or maintenance personal 370. Receipt of such an alert message 390 by a relevant user (360, 370) enables the user to attend to the indicated determined improper performance by one or more of the electronic detection devices (320-342) of the surveillance system 300.

In accordance with certain illustrated embodiments, the computer system 310 is preferably further operational and configured to generate a control signal for the one or more electronic detection devices (320-342) determined to have improper operational efficiency, step 460. The aforesaid control signal is preferably configured to affect proper operating efficiency upon the one or more electronic detection devices (320-342) determined to have improper operational efficiency, which control signal is preferably transmitted from the computer system 310 to the one or more electronic detection devices (320-342), via a computer network 100. For instance, examples of such a control signal may be (and is not to be understood to be limited to): rebooting of a camera, adjusting a pan-tilt-zoom capability of a camera, refocusing of optics, pinging message to further determine connectivity of a given device, and other like device changes.

Next, at step 470, upon network reception of the transmitted control signal (step 360), the one or more electronic detection devices (320-342) determined to have improper operational efficiency are preferably caused (320-342) to change one or more of their operating parameter/settings (or a reset of a device) so as to operate in compliance with predetermined proper operating efficiency associated with the one or more electronic detection devices (320-342).

In accordance with certain illustrated embodiments, at step 480, a compliance signal may preferable be transmitted from the one or more electronic detection devices (320-342) which changed one or more of their operating parameter/settings (step 470), via the control signal (step 460), back to the computer system 310 of surveillance system 300 indicating operation of the one or more electronic detection devices (320-342) is currently in compliance with its predetermined proper operating efficiency upon a change in one or more of its operating parameters.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

1-82. (canceled)

83. A system configured to evaluate an operational efficiency of one or more electronic devices in a vehicle checkpoint location, comprising:
a non-transient memory configured to store programmatic instructions; and
a processor disposed in communication with the memory, wherein, upon the processor's execution of the instructions, the system is configured to:
receive electronic data from one or more electronic detection devices that capture data associated with the vehicle, wherein the one or more electronic devices is configured to detect information about the vehicle upon entering the checkpoint location;
analyze the received electronic data to determine operational efficiency of the one or more electronic detection devices; and
generate and transmit an alert message if the one or more electronic detection devices is determined to have improper operational efficiency.

84. The system of claim 83, wherein the one or more electronic detection devices is at least one of a scene surveillance camera, a shipping container code camera, a license plate reader (LPR) camera, a face detection camera, a vehicle make/model/type/color decoding camera, a vehicle undercarriage scanning camera, a RFID scanner, or an inductive ground loop detector.

85. The system of claim 84, wherein the received electronic data from the one or more electronic detection devices includes one or more of: license plate decoding confidence scores, a number of license plates detected in an image field of view, vehicle make, model, type, and/or color classification confidence scores, a number of faces detected inside a given vehicle, a shipping container code, ISO 6346/MOCO decoding confidence scores, checksum values indicative of shipping container code values decoded to equate to a valid checksum value, a number of anomalies and/or foreign objects detected from an undercarriage imaging scan, a number of consecutive RFID reads of a first type that is consistent with an application scenario associated with a type of RFID tag.

86. The system of claim 83, wherein the electronic data comprise encrypted electronic data packets received from a computer network coupled to the one or more electronic detection devices.

87. The system of claim 86, wherein, upon the processor's execution of the instructions, the system is further configured to decrypt the encrypted electronic data packets transmitted, via the computer network, from the one or more electronic detection devices.

88. The system of claim 83, wherein, upon the processor's execution of the instructions, the system is further configured to analyze the received electronic data by determining a variance between the received electronic data and stored reference operating data for the one of more electronic detection devices.

89. The system of claim 88, wherein, upon the processor's execution of the instructions, the system is further configured to determine said improper operational efficiency of the one or more electronic detection devices when the determined variance exceeds a predetermined threshold indicative of improper device operation.

90. The system of claim 89, wherein the predetermined threshold is contingent upon a predetermined time period.

91. The system of claim 83, wherein, upon the processor's execution of the instructions, the system is further configured to analyze the received electronic data using a Statistical Computing Engine (SCE) module and wherein the SCE is configured to determine real-time statistics over a variable and a configurable window of data events.

92. The system of claim 83, wherein, upon the processor's execution of the instructions, the system is further configured to analyze the received electronic data by determining whether the one or more electronic detection devices is sending said electronic data after a prescribed number of vehicle events.

93. The system of claim 92, wherein the vehicle event is the vehicle entering a checkpoint location.

94. The system of claim 83, wherein, upon the processor's execution of the instructions, the system is further configured to compare data indicative of missing camera images against a predetermined baseline system configuration of an electronic detection device.

95. The system of claim 83, wherein, upon the processor's execution of the instructions, the system is further configured to utilize confidence scores to determine if the one or more electronic detection devices is out of focus, is out of alignment, is subject to degraded operation, or is subject to degraded imaging quality.

96. The system of claim 95, wherein the confidence scores include data relating to license plate decoders and facial detection of vehicle occupants.

97. The system of claim 83, wherein, upon the processor's execution of the instructions, the system is further configured to determine if sensory data and/or camera images are acquired in a predetermined order in association with predetermined timing and/or latency values.

98. The system of claim 97, wherein, upon the processor's execution of the instructions, the system is further configured to determine operational efficiency based upon a determined number of hard failures associated with the one or more electronic detection devices.

99. The system of claim 83, wherein, upon the processor's execution of the instructions, the system is further configured to determine operational efficiency based upon a determined number of preventative maintenance recommendations associated with the one or more electronic detection devices.

100. The system of claim 83, wherein, upon the processor's execution of the instructions, the system is further configured to generate a control signal for the one or more electronic detection devices determined to have improper operational efficiency, which control signal is configured to cause proper operating efficiency of the one or more electronic devices determined to have improper operational efficiency and wherein, upon reception of the transmitted control signal, the one or more electronic detection devices changes one or more of its operating parameters to operate in compliance with predetermined proper operating efficiency.

101. The system of claim 100, wherein the changes of one or more operating parameters includes at least one of resetting the one or more electronic detection devices or changing an operational setting of the one or more electronic detection devices.

102. The system of claim 101, wherein, upon the processor's execution of the instructions, the system is further configured to receive a compliance signal transmitted from the one or more electronic detection devices to the processor indicating operation of the one or more electronic detection devices is in compliance with its predetermined proper operating efficiency upon a change in one or more of its operating parameters.
